(19) United States
(12) Patent Application Publication
(10) Pub. No.: US 2019/0113989 A1
(43) Pub. Date: Apr. 18, 2019

(54) DIGIT MOUNTED STYLUS SYSTEM

(71) Applicant: Thomas Giese, Port Coquitlam (CA)

(72) Inventor: Thomas Giese, Port Coquitlam (CA)

(21) Appl. No.: 15/782,767

(22) Filed: Oct. 12, 2017

(51) Int. Cl. G06F 3/0354; G06F 3/0488

(52) U.S. Cl. CPC G06F 3/03545; G06F 2203/0331; G06F 3/04883

(57) ABSTRACT

A digit mounted stylus system includes a digit-cover having an open-end and a closed-end, and at least one raised protrusion configured on an outer surface of the digit-cover. The digit-cover is adapted to cover the tip of the digit of the user and enable a user to accurately use an electronic device via contact between the at least one raised protrusion and a screen of the electronic device. The device also allows for re-positioning of fingers and thumbs to relieve stress of single position use.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of hand-worn items and more specifically relates to a finger stylus.

### 2. Description of Related Art

A smartphone is a mobile personal computer with a mobile operating system with features useful for mobile or handheld use. Smartphones, which are typically pocket-sized, have the ability to place and receive voice/video calls and create and receive text messages, have virtual assistants, a note-taking application, an event calendar, a media player, video games, GPS navigation, digital camera and video camera. The display is almost always a touchscreen that enables the user to use a virtual keyboard to type words, numbers, and other characters, and press onscreen icons to activate “app” features. Often times the keyboard is small and difficult to navigate while texting or typing. A suitable solution is desired.

U.S. Pat. No. 8,970,558 to Damaris Dixie-Rose Gore relates to a digit apparatus for typing and texting. The described digit apparatus for typing and texting includes a digit hood to enable a user to quickly and accurately actuate keys of a hand held device. The digit hood can include a cover configured to be disposed over a digit. The cover can include an opening configured to receive the digit. One or more raised protrusions can extend from the cover and away from the digit for actuating the keys of the hand held device. A plurality of joint holes can be disposed through the cover to allow the digit to bend. A plurality of ventilation holes can be disposed through the cover to provide ventilation to the digit.

### BRIEF SUMMARY OF THE INVENTION

In view of the foregoing disadvantages inherent in the known hand-worn items art, the present disclosure provides a novel digit mounted stylus system. The general purpose of the present disclosure, which will be described subsequently in greater detail, is to provide an efficient and effective texting and typing aid.

A digit mounted stylus system is disclosed herein. The digit mounted stylus system includes a digit-cover having an open-end and a closed-end, and at least one raised protrusion configured on an outer surface of the digit-cover. The open-end of the digit-cover is configured to receive a tip of the digit of the user. The digit-cover is elasticized and configured to form fit cover the tip of the digit such as a finger or thumb of the user and enable a user to accurately use an electronic device via contact between the at least one raised protrusion and a screen of the electronic device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a digit mounted stylus system, constructed and operative according to the teachings of the present disclosure.

FIG. 1 is a perspective view of the digit mounted stylus system during an ‘in-use’ condition, according to an embodiment of the disclosure.

FIG. 2 is a perspective view of the digit mounted stylus system of FIG. 1, according to an embodiment of the present disclosure.

FIG. 3 is a perspective view of the digit mounted stylus system of FIG. 1, according to an embodiment of the present disclosure.

FIG. 4 is a perspective view of the digit mounted stylus system of FIG. 1, according to an embodiment of the present disclosure.

FIG. 5 is a perspective view of the digit mounted stylus system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to hand-worn items and more particularly to a digit mounted stylus system as used to improve the use of portable electronic devices.

Generally, the device includes a finger or thumb end cap or ring that has raised portion(s) in one or more arrears to facilitate using proper keys on smartphones. The device may be made from materials compatible with face screens of smartphones. The digit mounted stylus system will not mark the surfaces of electronic devices. The device may include colored materials or be stamped with caricatures to appeal to all ages of users and may be provided in a wide range of sizes (to suit all ages and sexes) thumbs and fingers. The device allows for repositioning of fingers and thumbs to relieve stress of single position use.

A neck string may be included to attach to the device when not in use. A full glove option may be available for cold weather texting. The glove may consist of a cotton glove with raised protrusions. The glove could be on a neck string for ease of use. Digit mounted stylus system may be fabricated in a round configuration to make it easy to move to multiple positions for comfortable use. The digit mounted stylus system does not extend past the first knuckle for comfort when using. Digit mounted stylus system is compact enough for normal use of hands and fingers when not being used for smartphone. The device may be used by user's with arthritis or other deformities which may present difficulties with texting and using small keyboards.

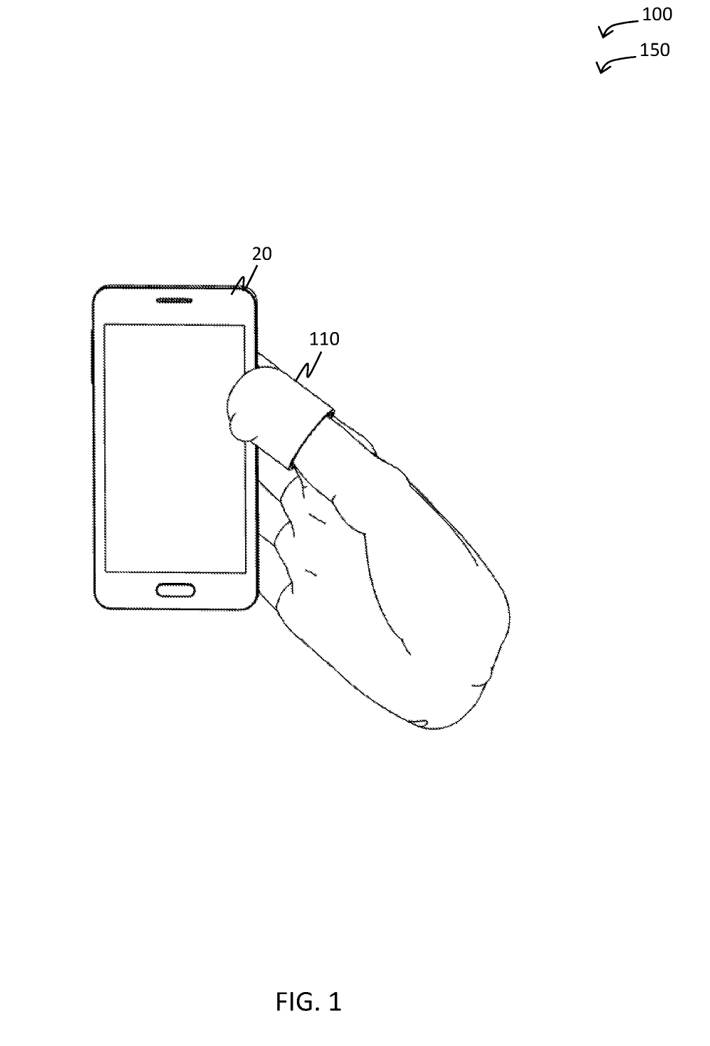

Referring now more specifically to the drawings by numerals of reference, there is shown in FIGS. 1-5, various views of a digit mounted stylus system 100. FIG. 1 shows a digit mounted stylus system 100 during an ‘in-use’ condition 150, according to an embodiment of the present disclosure. As illustrated, the digit mounted stylus system 100 may include a digit-cover 110 having an open-end 120 and a closed-end 124, and at least one raised protrusion 130 configured on an outer surface of the digit-cover 110. The open-end 120 of the digit-cover is configured to receive a tip of the digit 10 of a user. The digit-cover 110 is configured to cover the tip of the digit 10 of the user and enable the user to accurately use an electronic device 20 via contact between the at least one raised protrusion 130 and a screen of the electronic device 20.

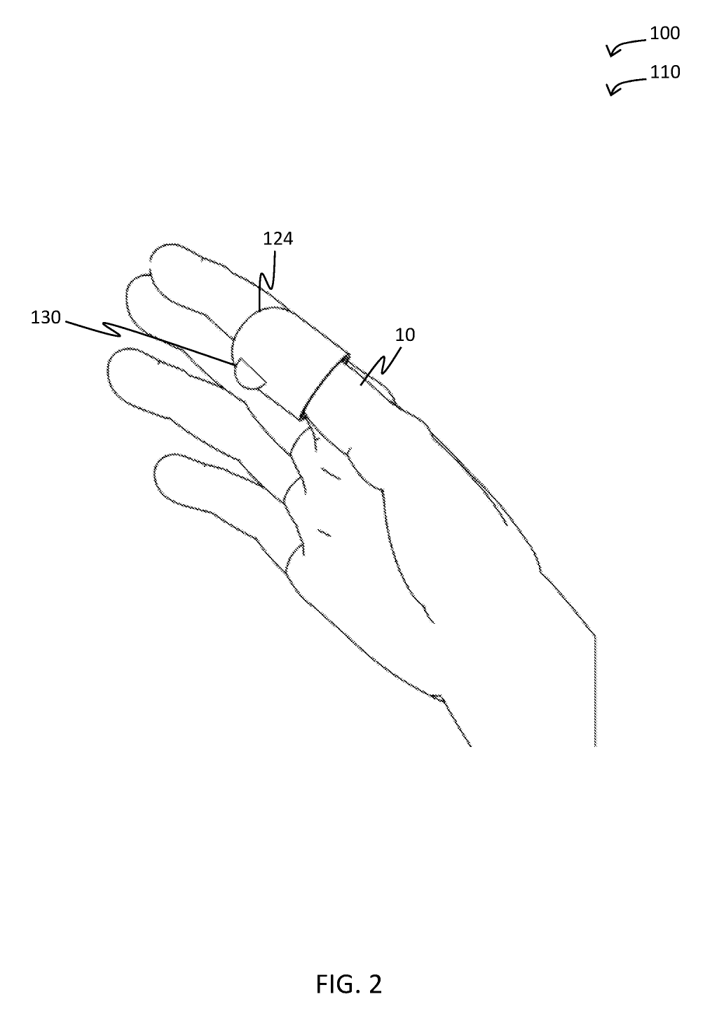

FIG. 2 shows a perspective view of the digit mounted stylus system 100 of FIG. 1, according to an embodiment of the present disclosure. As above, the digit mounted stylus system 100 may include the digit-cover 110 and at least one raised protrusion 130 configured on an outer surface of the digit-cover 110. The device may be placed on a tip of the digit 10 including a finger or thumb and provide a fingertip stylus for allowing a user to type accurately and quickly on a small electronic device 20. The screen of the electronic device 20 such as a mobile phone is a touch-screen. The at least one raised protrusion 130 is positioned centrally on a bottom side of the digit-cover 110 proximate to a pad of the digit 10. The at least one raised protrusion 130 comprises conductive rubber creating a stylus to interact with the screen of an electronic device 20.

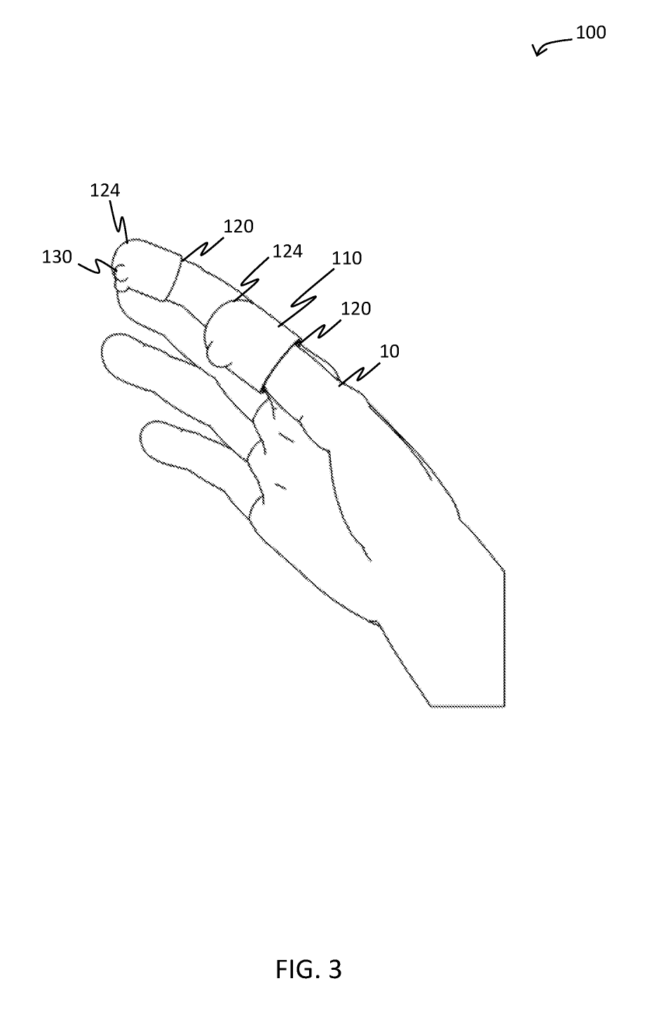

FIG. 3 shows a perspective view of the digit mounted stylus system 100 of FIG. 1, according to an embodiment of the present disclosure. As above, the digit mounted stylus system 100 may include a digit-cover 110 having the open-end 120 and the closed-end 124. The digit-cover 110 may include two raised protrusions 130. The digit-cover 110 does not extend past a first knuckle allowing for full movement of one's finger or thumb with the device. The digit-cover 110 is flexible and is configured to form fit the digit 10 of the user. In a preferred embodiment, the digit-cover 110 is removeable and reusable. The digit-cover 110 is elasticized. The digit-cover 110 may be provided in a ring-like configuration or finger cap configuration.

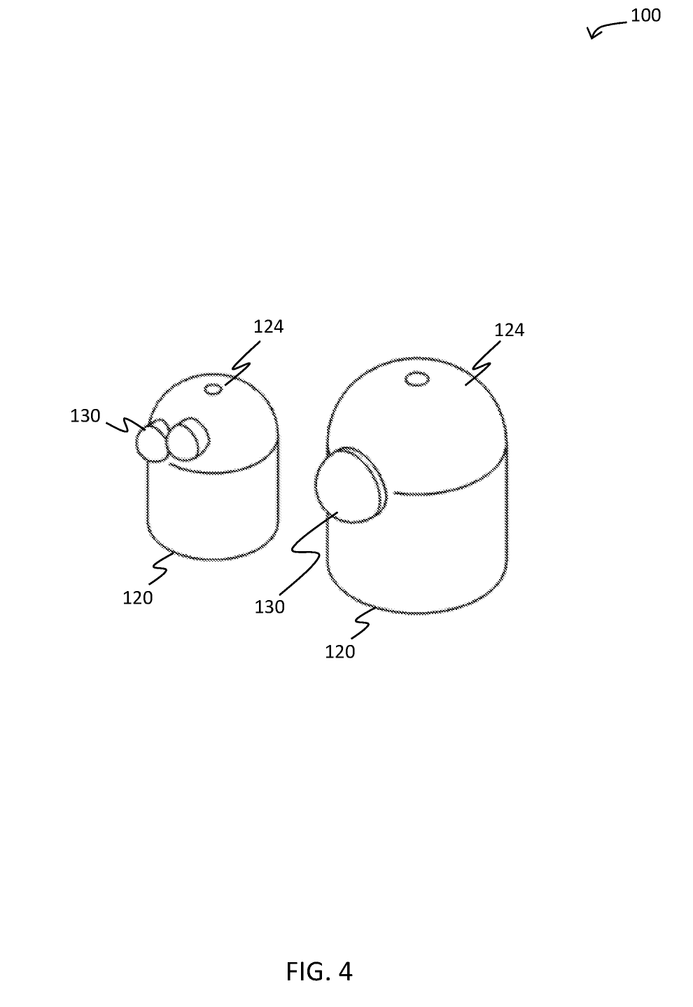

FIG. 4 shows a perspective view of the digit mounted stylus system 100 of FIG. 1, according to an embodiment of the present disclosure. As above, the digit mounted stylus system 100 may include a reusable storage pouch for storage during non-use. In alternative embodiments, the digit mounted stylus system 100 may also include a glove having raised protrusions 130 on one or multiple fingertips. The glove may be used for cold weather texting and comprise a cotton glove with raised protrusions 130. The digit mounted stylus system 100 may further include a neck-strap for storage between use.

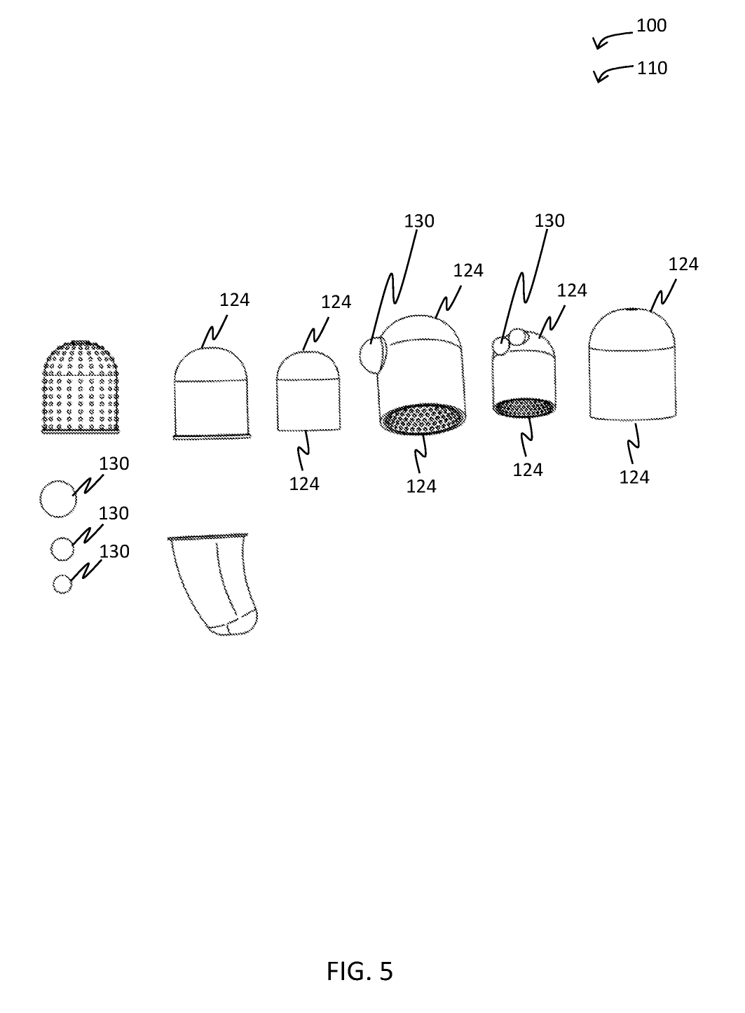

FIG. 5 shows a perspective view of the digit mounted stylus system 100 of FIG. 1, according to an embodiment of the present disclosure. As above, the digit mounted stylus system 100 may include the digit-cover 110 and at least one raised protrusion 130 configured on an outer surface of the digit-cover 110. The raised protrusion 130 may be rounded, coned or other shapes for various uses on a keyboard or touch-screen. The digit-cover 110 may comprise a variety of rubber and synthetics as well as stretchable cloth materials. Other materials may be used.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A digit mounted stylus system comprising:
a digit-cover having an open-end and a closed-end; and
at least one raised protrusion configured on an outer surface of said digit-cover;
wherein said open-end of said digit-cover is configured to receive a tip of said digit of said user; and
wherein said digit-cover is configured to cover said tip of said digit of said user and enable a user to accurately use an electronic device via contact between said at least one raised protrusion and a screen of said electronic device.

2. The digit mounted stylus system of claim 1, wherein said digit comprises a finger.

3. The digit mounted stylus system of claim 1, wherein said digit comprises a thumb.

4. The digit mounted stylus system of claim 1, wherein said screen of said electronic device is a touch-screen.

5. The digit mounted stylus system of claim 1, wherein said at least one raised protrusion is positioned centrally on a bottom side of said digit-cover proximate to a pad of said digit.

6. The digit mounted stylus system of claim 1, wherein said at least one raised protrusion comprises conductive rubber.

7. The digit mounted stylus system of claim 1, wherein said digit-cover comprises two of said at least one raised protrusions.

8. The digit mounted stylus system of claim 1, wherein said digit-cover does not extend past a first knuckle.

9. The digit mounted stylus system of claim 8, wherein said digit-cover is flexible.

10. The digit mounted stylus system of claim 9, wherein said digit-cover is configured to form fit said digit of said user.

11. The digit mounted stylus system of claim 10, wherein said digit-cover is removeable.

12. The digit mounted stylus system of claim 11, wherein said digit-cover is elasticized.

13. The digit mounted stylus system of claim 1, wherein said digit-cover comprises a ring-like configuration.

14. The digit mounted stylus system of claim 1, further comprises a reusable storage pouch for storage during non-use.

15. The digit mounted stylus system of claim 4, wherein said electronic device comprises a mobile phone.

16. The digit mounted stylus system of claim 1, further comprises a glove having at least one raised protrusion.

17. The digit mounted stylus system of claim 1, further comprises a neck-strap.

18. The digit mounted stylus system of claim 1, wherein said at least one raised protrusion comprises a coned profile.

19. The digit mounted stylus system of claim 1, wherein said at least one raised protrusion comprises a rounded profile.

20. A digit mounted stylus system comprising:
a digit-cover having an open-end and a closed-end; and
at least one raised protrusion configured on an outer surface of said digit-cover;
wherein said digit-cover does not extend past a first knuckle;
wherein said digit-cover is flexible;
wherein said digit-cover is configured to form fit said digit of said user;
wherein said digit-cover is removeable;
wherein said digit-cover is elasticized;
wherein said at least one raised protrusion is positioned centrally on a bottom side of said digit-cover proximate to a pad of said digit;
wherein said at least one raised protrusion comprises conductive rubber;
wherein said at least one raised protrusion comprises a rounded profile;
wherein said open-end of said digit-cover is configured to receive a tip of said digit of said user;
wherein said digit-cover is configured to cover said tip of said digit of said user and enable a user to accurately use an electronic device via contact between said at least one raised protrusion and a screen of said electronic device;
wherein said digit comprises a finger or a thumb;
wherein said screen of said electronic device is a touch-screen; and
wherein said electronic device comprises a mobile phone.
